(19) United States
(12) Patent Application Publication
(10) Pub. No.: US 2009/0243247 A1
(43) Pub. Date: Oct. 1, 2009

(54) SUSPENSION SYSTEM STRUCTURE AND METHOD OF ASSEMBLY

(76) Inventors: Gregory A. Richardson, Nixa, MO (US); Richard Lee Conaway, Grand Haven, MI (US)

Correspondence Address: George Pappas, 919 S. Harrison Street, Suite 300, Fort Wayne, IN, 46802, US

(21) Appl. No.: 12/383,521

(22) Filed: Mar. 25, 2009

Related U.S. Application Data
(60) Provisional application No. 61/039,789, filed on Mar. 26, 2008.

(51) Int. Cl. B62D 21/11; B21D 53/88

(52) U.S. Cl. 280/124.109; 29/897.2

(57) ABSTRACT

A sliding suspension system for a trailer chassis. The suspension includes two longitudinally extending slide rails and an axle assembly having two axles. At least one suspension spring member dampens relative movement between the axle assembly and the trailer chassis. At least one laterally extending cross beam is secured to the longitudinally extending rails. The suspension system also includes four bracing members and at least one central connecting member. Two of the bracing members are secured to and extend between one of the rails and the central connecting member while the other two bracing members are secured to and extend between the other rail and the central connecting member. The bracing members are arranged in an X-shaped configuration between the two rails. In some embodiments, the bracing members have an S-shaped cross section. A method of assembling a sliding suspension system for a trailer chassis is also disclosed.

### CROSS REFERENCE TO RELATED APPLICATIONS

This application claims priority under 35 U.S.C. 119(e) of U.S. provisional patent application Ser. No. 61/039,789 filed on Mar. 26, 2008 entitled TRAILER SLIDER SUSPENSION ASSEMBLY AND METHOD OF MANUFACTURE the disclosure of which is hereby incorporated herein by reference.

### BACKGROUND OF THE INVENTION

1. Field of the Invention

The present invention relates to suspension systems and, more particularly, to suspension systems that are adapted for use with large trailers such as semi-trailers.

2. Description of the Related Art

Large semi-trailers are widely used to haul goods and other loads. Such trailers include suspension systems and many such trailers include sliding suspension systems that can be longitudinally repositioned on the trailer to position one or more the trailer axles at an appropriate location to support the load that is being hauled.

A number of variables and conditions have an impact on the performance and cost of such suspension systems. For example, if the axles of the suspension system are not positioned perpendicular to the longitudinal line of travel the performance of the suspension system can be adversely impacted. This can be of particular importance to sliding suspension systems where the longitudinal position of the axles is selectively adjustable. Such large trailers are also potentially subject to roll-over when they encounter large lateral forces, e.g., horizontal lateral forces exerted by cross winds that impinge upon the trailer. The suspension system of the trailer will be one factor in determining the roll-over stability of the trailer when it encounters such lateral forces. Moreover, trailers are manufactured in various sizes and the relative ease with which a suspension system can be adapted to fit various sized trailers can have an impact on the cost of the suspension system. While there are many known suspension systems for such trailers, an improved suspension system is desirable.

### SUMMARY OF THE INVENTION

The present invention provides a sliding suspension system that can be efficiently assembled to fit different width trailer chassis. A method of assembling a sliding suspension system is also disclosed.

The invention comprises, in one form thereof, a sliding suspension system for mounting on a trailer chassis defining a longitudinal axis. The suspension system includes first and second longitudinally extending slide rails which are slidably engageable with the trailer chassis. An axle assembly is secured to the suspension system and includes first and second axles extending substantially perpendicular to the longitudinal axis. At least one suspension spring member is coupled with the axle assembly and adapted to dampen relative movement between the axle assembly and the trailer chassis. At least one laterally extending cross beam secured to the first rail and to the second rail. The suspension system also includes first, second, third and fourth bracing members and at least one central connecting member. The first and second bracing members are each secured to and extend between the first rail and the central connecting member while the third and fourth bracing members are each secured to and extend between the second rail and the central connecting member. The four bracing members are arranged in a substantially X-shaped configuration between the first and second rails.

In some embodiments of the invention, the central connecting member includes first and second substantially planar metal plates and each of said bracing members includes a first flange, a second flange and a central web extending between said first and second flanges to define an S-shaped cross section. The first metal plate is secured to the first flange of each of the bracing members and said second metal plate is secured to the second flange of each of the bracing members.

The invention comprises, in another form thereof, a method of assembling a sliding suspension system for a trailer chassis. The method includes providing first and second slide rails adapted to be slidably engaged with the trailer chassis; providing a cross beam; providing at least one connecting member; and providing first, second, third and fourth bracing members. The first and second rails are secured together wherein the first and second rails are disposed substantially parallel to thereby define a longitudinal axis by attaching the cross beam to the first rail with at least one fastener and to the second rail with at least one fastener; attaching the first and second bracing members to the first rail with at least one fastener and to the at least one connecting member with at least one fastener; and attaching the third and fourth bracing members to the second rail with at least one fastener and to the at least one connecting member with at least one fastener. The bracing members are arranged in a substantially X-shaped configuration between the first and second rails after being secured to the rails and at least one connecting member. An axle assembly is attached to the suspension system wherein the axle assembly includes first and second axles extending substantially perpendicular to the longitudinal axis and at least one suspension spring member is mounted on the suspension system wherein the suspension spring member is positioned to dampen movement of the axle assembly.

### BRIEF DESCRIPTION OF THE DRAWINGS

The above mentioned and other features of this invention, and the manner of attaining them, will become more apparent and the invention itself will be better understood by reference to the following description of embodiments of the invention taken in conjunction with the accompanying drawings, wherein:

FIG. 1 is a perspective view of a slider suspension assembly constructed in accordance with the principles of the present invention;

FIG. 2 is a top plan view of the slider suspension assembly shown in FIG. 1;

FIG. 3 is a side elevation view of the slider suspension assembly shown in FIG. 1 with the spider and air spring bracket removed from one of the axles and the mounting bracket and spring member removed from the leaf spring;

FIG. 4 is a rear elevation view of the slider suspension assembly shown in FIG. 1;

FIG. 5 is an exploded view of the cross brace and slide rails of the slider suspension assembly shown in FIG. 1;

FIG. 6 is a cross sectional view of the slider suspension assembly taken along line A-A of the side view shown in FIG. 6(a) and depicting the lean angle between the trailer and axles at 0.0° as shown in the end view of FIG. 6(b);

FIG. 7 is a cross sectional view of the slider suspension assembly taken along line A-A of the side view shown in FIG. 7(a) and depicting the lean angle between the trailer and axles at 1.55° as shown in the end view of FIG. 7(b);

FIG. 8 is a cross sectional view of the slider suspension assembly taken along line A-A of the side view shown in FIG. 8(a) and depicting the lean angle between the trailer and axles at 2.50° as shown in the end view of FIG. 8(b);

FIG. 9 is a cross sectional view of the slider suspension assembly taken along line A-A of the side view shown in FIG. 9(a) and depicting the lean angle between the trailer and axles at 7.46° as shown in the end view of FIG. 9(b);

FIG. 10 is a cross sectional view taken along line 10-10 of FIG. 2 and depicting the pivotable adjustment link in its longitudinally centered position;

FIG. 11 is a cross sectional view taken along line 10-10 of FIG. 2 and depicting the pivotable adjustment link in its longitudinally forward position;

FIG. 12 is a cross sectional view taken along line 10-10 of FIG. 2 and depicting the pivotable adjustment link in its longitudinally rearward position;

FIG. 13 is a perspective view of the pivotable adjustment link and mating “H” block constructed in accordance with the principles of the present invention;

FIG. 14 is a perspective view of the “H” block shown in FIG. 13;

FIG. 14a is a side view of the “H” block shown in FIG. 13;

FIG. 15 is a diagrammatic graph of the operation of the slider suspension assembly depicting the opposing spring rate on one lateral side of the suspension assembly as a function of the degrees of lean caused by turning of the trailer or by a horizontal lateral force; and

FIG. 16 is a side view of an alternative slider suspension assembly constructed in accordance with the principles of the present invention with the spider and air spring bracket removed from one of the axles.

Corresponding reference characters indicate corresponding parts throughout the several views. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION OF THE INVENTION

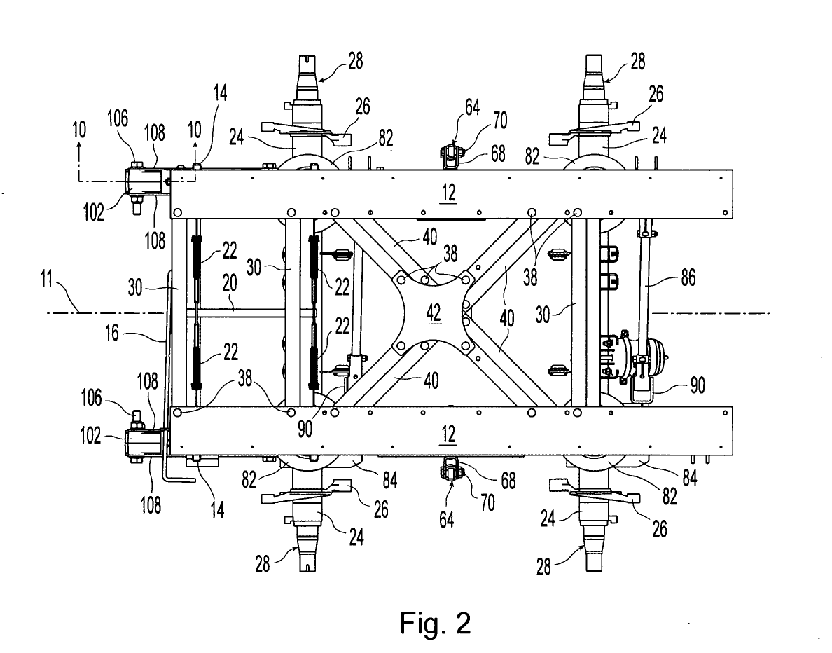

A slider suspension assembly constructed in accordance with the principles of the present invention is shown and generally designated in the drawings by the numeral 10. The illustrated assembly 10 includes longitudinally extending slide rails 12 adapted to be received in and mate with a vehicle chassis 13 such as a semi-trailer chassis in a known and customary manner. That is, slide rails 12 and the assembly 10 supported thereon are adapted to adjustably slide longitudinally along a trailer chassis 13 and be locked in one of various longitudinal positions along the trailer chassis 13 with locking pins 14 which are selectively movable in and out of locking holes on the trailer chassis rails. The longitudinal axis 11 defined by rails 12 and chassis 13 is shown in FIG. 2.

The locking pins 14 are selectively movable laterally in and out of their corresponding locking holes with a locking pin assembly comprising a pull arm 16 pivotally connected to the radial arm 18 which is, in turn, connected to shaft 20. Shaft 20 is pivotally secured to springs 22 which are pivotally connected to the locking pins 14 and provide a retracting force for pulling the locking pins 14 inboard toward the shaft 20.

Slide rails 12 are part of a frame assembly from which the suspension system and axles 24 depend such that the entire slider suspension assembly 10 is a pre-assembled unit for mounting under and use in supporting a trailer chassis. It is noted that brake spiders 26 are provided on the axles 24 and the axles 24 include spindles 28 at their terminal ends for rotatably receiving wheels thereon (not shown).

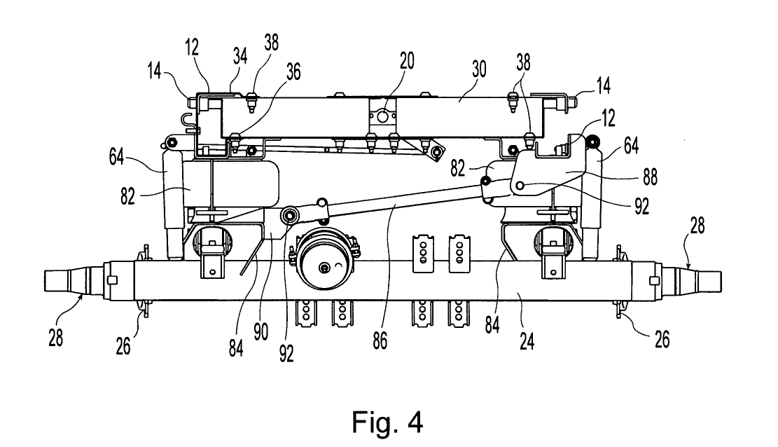

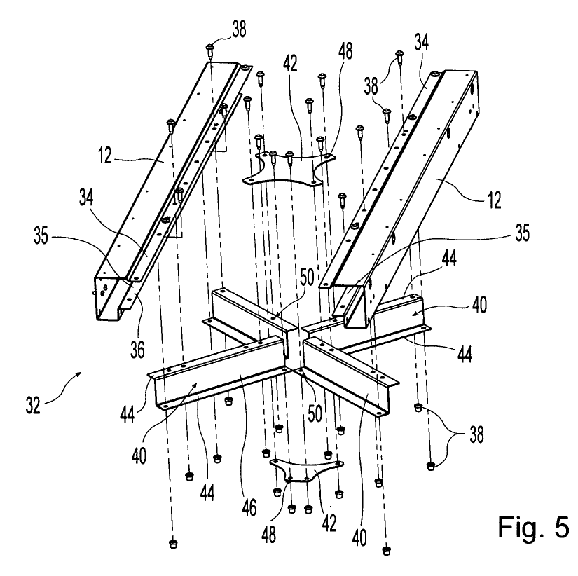

The frame assembly advantageously rigidly secures the slide rails 12 together with lateral cross beams 30 and a cross or “X” brace assembly 32. As can be seen in FIG. 5, slide rails 12 have a generally C-shaped cross section with projecting flanges 34, 36 disposed at opposite ends of the opening 35 formed by the C-shaped cross section. As best seen in FIG. 4, the lateral cross beams 30 extend perpendicular to and between each of the slide rails 12 and are attached to the slide rails upper flange 34 and lower flange 36. Lateral cross beams 30 are rigidly attached to the slide rails 12 using fasteners 38. Fasteners 38 are preferably installed such that the tensile forces in the shaft of the installed fastener are predefined and, thus, the clamping force exerted by the fastener on the two parts being secured together is also a predefined clamping force. Many types of fasteners can be used to provide such a predefined clamping force. For example, threaded fasteners taking the form of a conventional nut and bolt can be installed to a predefined torque. Non-threaded fasteners such as rivets can also be employed. As those having ordinary skill in the art will recognize, a fastener having a frangible component that is separated from the remainder of the fastener when the fastener is secured at the desired clamping force provides a convenient method of securing fasteners 38 at a predefined clamping force. In the illustrated embodiment, fasteners 38 used to secure beams 30 to rails 12 are what are commonly referred to as “Huck fasteners” by those having ordinary skill in the art. The illustrated Huck fasteners 38 employ a frangible component to enable the fastener to be quickly and easily installed while still providing a consistent uniform predefined clamping force.

The cross or “X” brace 32 is provided for securing the slide rails 12 longitudinally with respect to one another and, together with the cross beams 30, maintain the slide rails in their respective positions relative to the trailer chassis. The cross or “X” brace assembly 32, as best seen in FIG. 5, comprises four (4) bracing members 40 and a pair of central connecting members 42 used for securing the bracing members 40 in an “X” configuration. Connecting members 42 take the form of substantially planar metal plates in the illustrated embodiment. Preferably, bracing members 40 are “S” shaped in cross section and are made by bending a sheet of metal so as to form the upper and lower flanges 44 and the central web 46. Bracing members 40 could also be I-beam shaped for yet additional rigidity. The center plates 42 are provided with holes 48 whereby threaded fasteners 38 are received therethrough and through corresponding holes 50 on the bracing member flanges 44 for thereby securing the center plates 42 on the upper and lower flanges 44 of the bracing members 40 and thereby forming the cross or “X” brace 32. The center plates 42 thus act as a hub for rigidly securing the bracing members 40 extending away therefrom in an “X” configuration. The terminal ends of the bracing members 40 are in turn rigidly secured to the slide rails 12 similarly to the lateral cross beams 30. That is, the upper and lower flanges 44 of the terminal ends of the bracing members 40 are secured to the slide rails 12 upper and lower flanges 34, 36 with threaded fasteners 38. The fasteners 38 securing the center plates 42 to the bracing members 40 and the fasteners 38 securing the bracing members 40 to the slide rails 12 are similarly nut and bolt fasteners or, most preferably, are Huck fasteners for more rigidly, easily and quickly providing securement of the components as shown.

As should now be appreciated, advantageously, the length of the lateral cross beams 30 and bracing members 40 are selectively adjustable for thereby selectively locating the slide rails 12 at any desired lateral distance from one another for accommodating various trailer chassis sizes. Thus, various frame assemblies need not be maintained in stock for accommodating various trailer chassis but, rather, frame assemblies of various sizes can merely more easily and quickly be assembled for accommodating various size trailer chassis by simply varying the length and/or shape of the lateral cross beams 30 and the bracing members 40.

More specifically, a manufacturer of sliding suspension systems for trailers can maintain a minimal inventory of parts for assembling a suspension system for trailers requiring suspension systems having different widths and/or lengths. All that is required to vary the width of a suspension assembly 10 is to alter the length of cross beams 30 and bracing members 40. Thus, by maintaining an inventory of variable length cross beams 30 and variable length bracing members 40, once the manufacturer has determined the lateral width associated with the desired suspension system, the manufacturer can simply select a cross beam 30 having an appropriate length for the desired lateral width and select four bracing members 40 of an appropriate length for the desired lateral width and then assemble the suspension system 10.

Similarly, by also maintaining an inventory of variable length rails 12, the manufacturer can easily adjust the length of rails 12 by determining the desired length simply selecting the rails having the desired rail length. Depending upon the trailer which will be receiving the suspension system, the width and length of the suspension system 10 necessary to fit the trailer can vary. The suitable lengths of cross beams 30, bracing members 40 and rails 12 can be determined in advance for common trailer dimensions. An inventory of cross beams 30, bracing members 40 and rails 12 in lengths suitable for the most common trailer dimensions can then be maintained and determining the desired length and width may be as simple as identifying the trailer on which the suspension system 10 will be mounted. It is also possible to cut down cross beams 30, bracing members 40 and rails 12 to fit a particular trailer or custom manufacture these items.

In the illustrated embodiment, bracing members 40 in assembly 10 each have a substantially common length and are disposed at an approximately 45 degree angle relative to longitudinal axis 11. Alternative embodiments, however, could utilize four bracing members 40 arranged in a different configuration and having two or more lengths. By using four bracing members 40 having a common length in suspension assembly 10, the efficient manufacture of assembly 10 is facilitated.

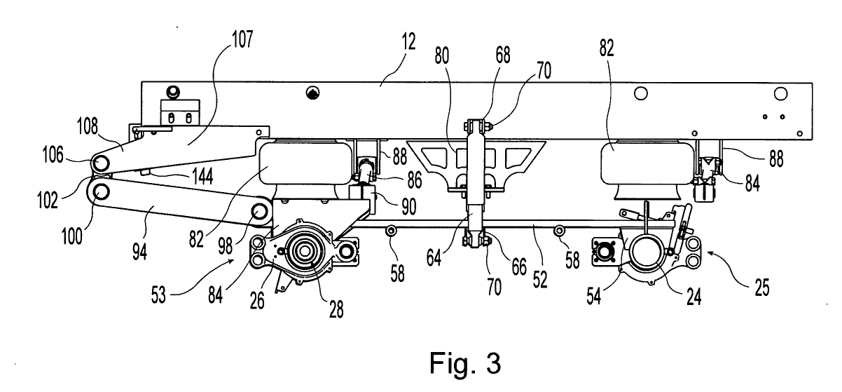

The suspension system 10 is adapted to secure an axle assembly 25 to the frame assembly and vehicle chassis 13. In the illustrated embodiment, axle assembly 25 includes a pair of axles 24. More particularly, axle assembly 25 includes two axles 24 which each extend substantially perpendicular to longitudinal axis 11 and two longitudinal assemblies 53. The longitudinal assemblies 53 are positioned below and supported by a corresponding one of the rails 12. The two longitudinal assemblies 53 are located on opposite sides of longitudinal axis 11 and extend between the two axles 24. Longitudinal assemblies 53 each include a leaf spring or flexible beam member 52 that secure the two axles 24 together. Leaf springs 52 extend longitudinally and generally parallel. Leaf springs 52 are positioned underneath the slide rails 12 and are substantially perpendicular to the axles 24. As best seen in FIG. 3, leaf spring brackets 54 are secured to the axle 24 by welding or other suitable means and the leaf springs 52 are, in turn, secured to the brackets 54 also by welding or other suitable means. Thus, leaf springs 52 rigidly secure the axles 24 to one another and, depending on the spring rate/stiffness of the leaf spring 52, provide vertical flexibility between the axles 24.

The longitudinal assemblies 53 also include various brackets and fixtures to provide attachment points such as leaf spring brackets 54, mounting bracket 56 and spring brackets 84. More specifically, each of the leaf springs 52 are provided with a generally U-shaped in cross section mounting bracket 56 which extends over and receives the leaf spring 52 therethrough. Sleeves 58 are secured to the leaf springs 52 by welding or other suitable means and are adapted to receive the fastening bolts 60 therethrough. Corresponding holes are provided on the legs 62 of the U-shaped brackets 56 for also receiving the fastening bolts 60 therethrough and thereby pivotally securing the mounting bracket 56 to the leaf spring 52. Accordingly, the U-shaped mounting brackets 56 are pivotally secured to the leaf spring 52 at the sleeves 58 and, therefore, leaf springs 52 are allowed to flex therebetween.

A pair of lift limiting members 64 taking the form of telescoping shock absorbers in the illustrated embodiment are provided on each lateral side of the suspension assembly and are each pivotally mounted between the U-shaped mounting brackets 56 and the slider rails 12. More particularly, lower shock absorber brackets 66 are provided and secured to each of the inboard and outboard legs 62 of mounting brackets 56, and corresponding upper shock absorber brackets 68 are provided and are secured to the slider rails 12. The shock absorbers 64 are pivotally secured between the lower and upper shock absorber brackets 66, 68 with fastening bolts 70. The shock absorbers 64 provide dampening between the slide rails 12 and the suspension system mounting brackets 56. It is further noted that shock absorbers 64 provide for a maximum extension such that, in the event axles 24 and, thus, brackets 56 are pulled away from the slide rails 12, upon reaching maximum extension the shock absorbers 64 will cause the axles 24 to be lifted or, stated differently, will prevent further movement of the axles 24 away from the slide rails 12 and thus define a lift limiting member. While the use of telescoping shock absorbers provides lift limiting members 64 that also function as dampening elements, a chain or other flexible member having an adequate strength could alternatively be secured to brackets 56 and rails 12 to function as lift limiting members limit the distance by which brackets 56 and rails 12 can be separated as the trailer is tipped laterally.

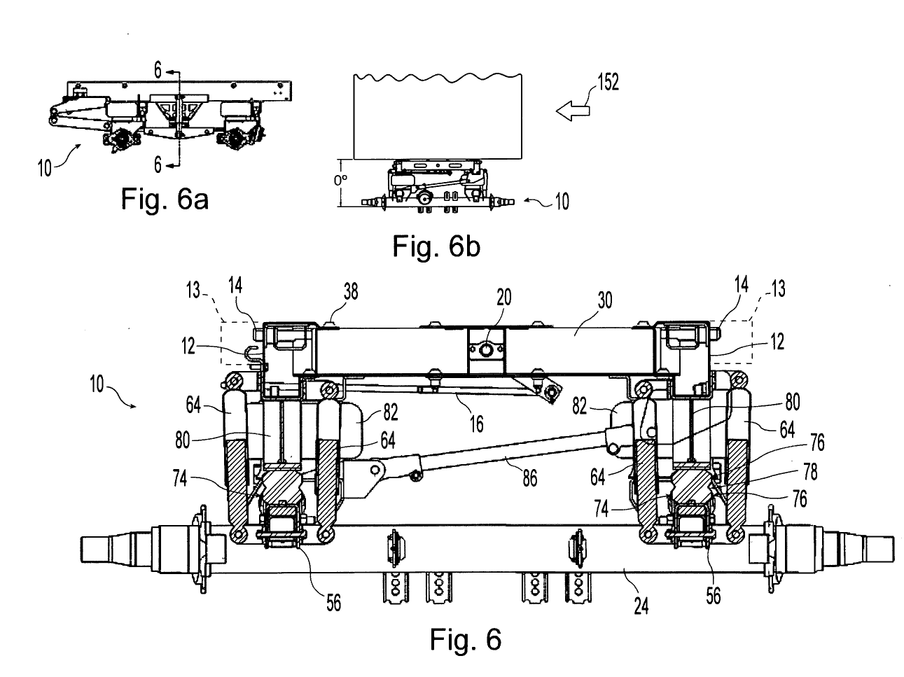

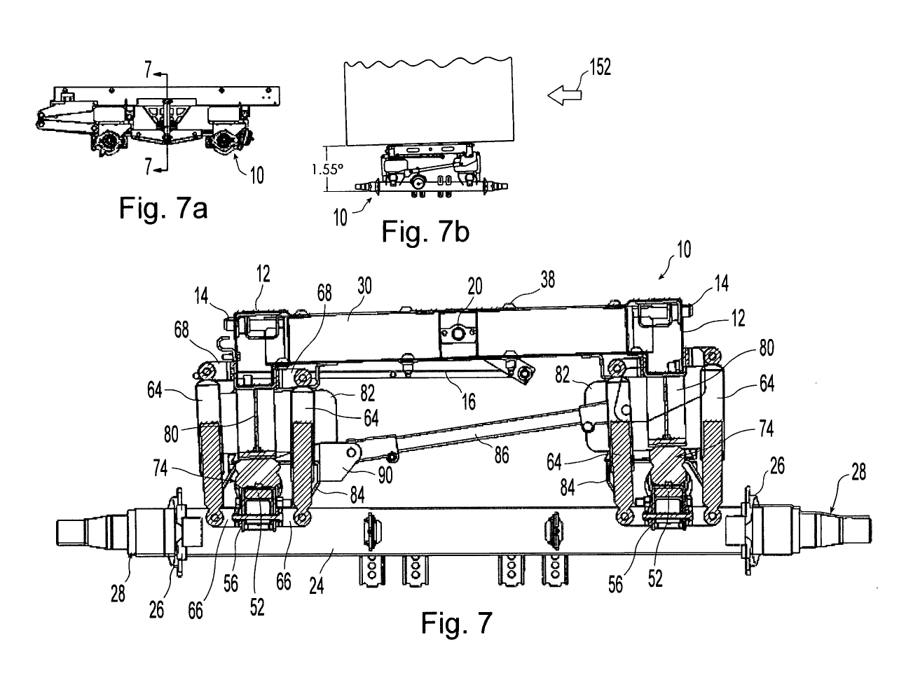

Between the shock absorbers 64 and generally centered on the supporting bracket upper center face 72 there is provided a spring member 74. In the illustrated embodiment, spring member 74 is formed out of a resiliently compressible material and, more specifically, is formed out of a rubber material. Spring member 74 preferably includes, as best seen in FIGS. 6-9, upper and lower bulbous sections 76 and a central thinner area 78. Rubber spring members of this character are commercially available and sold under the trade name of Timbren. As can be appreciated by one skilled in the art, when compressing the spring member 74 the initial spring rate thereof is lower as a result of the central thinner area 78 and the upper and lower bulbous sections 76 coming closer together and essentially filling the central thinner area 78. As the upper and lower bulbous sections 76 come closer together and essentially fill the central thinner area 78, as for example shown in FIGS. 7-9, the spring rate of the rubber spring member 74 substantially increases.

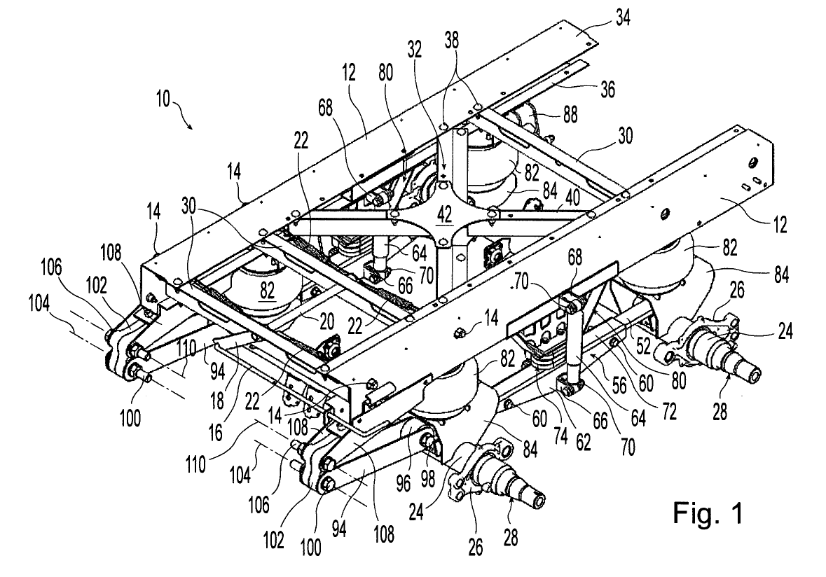

As best seen in FIGS. 1 and 6-9, a filler bracket 80 is provided between each of the slide rails 12 and the corresponding rubber spring member 74 thereunder. Accordingly, compressive forces, i.e. the forces experienced as a result of the weight of the trailer and the forces experienced during turning of the trailer, may be directly transferred from or through the axles 24 to the leaf springs 52 through mounting brackets 56 which are biasingly coupled with the rubber spring members 74. These forces are transferrable from spring members 74 through filler bracket 80 to the slide rails 12.

Compressive forces are also transferred from or through the axles 24 to the slide rails 12 using four (4) air springs 82. Each of the air springs 82 in assembly 10 are located between the slide rails 12 and an axle 24. More particularly, longitudinal assemblies 53 include U-shaped spring brackets 84 positioned over the leaf spring brackets 54 and which are welded to the axles 24 as best seen in FIG. 1. Thus, compressive forces are transferred from or through the axles 24 through the spring brackets 84 and the air springs 82 to the slide rails 12 and chassis 13.

For providing lateral stability, a pair of lateral rods or track bars 86 are provided and are pivotally secured between the slide rails 12 and the spring brackets 84. As best seen in FIG. 4, under brackets 88 are secured to the slide rail 12, and lateral brackets 90 are secured to the spring brackets 84. The track bars 86 are pivotally secured between the lateral brackets 90 and the under brackets 88 with fasteners 92. Preferably, two (2) track bars 86 are provided, one corresponding to each of the axles as shown in FIGS. 2 and 3.

Longitudinal stability of the suspension assembly and axles 24 is provided with a pair of trailing arms 94 which act to pivotally secure axle assembly 25 with its axles 24 to the slide rails 12. Trailing arms 94, at one end thereof, are pivotally coupled to axle assembly 25 at a corresponding leaf spring 52 and spring bracket 54 with a bushing 96 and fastening bolt 98. Trailing arms 94 are pivotally supported relative to chassis 13 at their other terminal ends where the trailing arms 94 are pivotally secured with fastening bolts 100 to a pivotal link 102. Thus, each of the trailing arms 94 are adapted to pivot about the lateral axis 104 extending concentrically through the fasteners 100.

Pivotal links 102 are pivotally secured with fasteners 106 to the alignment bracket legs 108. Thus, each pivotal link 102 is itself adapted to pivot about a lateral axis 110 which extends concentrically through the fasteners 106. It is contemplated that bushings will be used around the fasteners 100 and 106 for providing some flexibility therebetween as may be needed or desired.

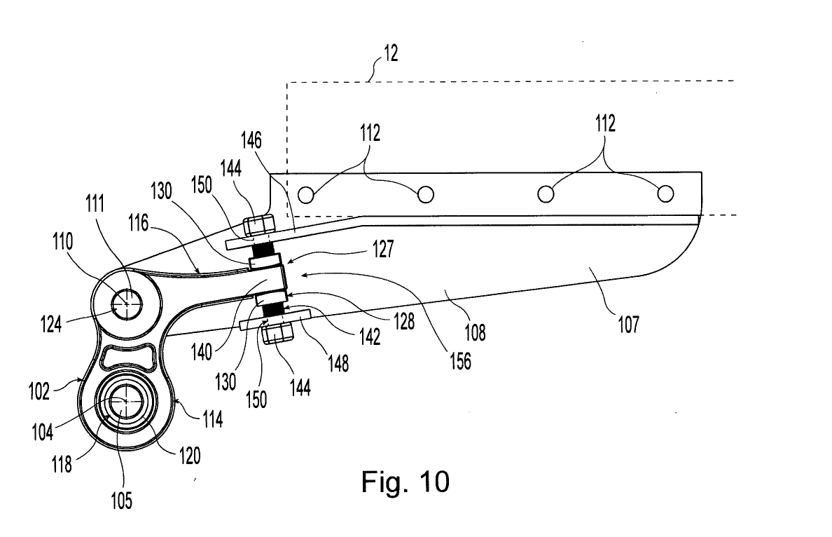

Referring now more particularly to FIGS. 10-12 which depict a cross sectional view along line 10-10 of FIG. 2, the pivotal link 102 is shown as it is pivotally secured to the alignment bracket legs 108 of alignment bracket 107. The alignment bracket legs 108 are secured to the slide rails 12 shown in dash lines in FIG. 10 through the use of fasteners (not shown) extending through aligned holes 112 through the alignment bracket legs 108 and the slider rails 12. Pivotal link 102, as shown, is adapted to pivot about the fastener 106 which extends through holes (not shown) extending through the legs 108. Accordingly, each of the pivotal links 102 pivot with respect to their respective alignment bracket legs 108 about the lateral axis 110.

Pivotal link 102 is generally “L” shaped and includes a trailing arm attachment leg 114 and an adjustment leg 116. A pivotal connection 105 pivotally secures pivotal links 102 with trailing arms 94 about a pivot axis 104 that extends laterally and substantially perpendicular to longitudinal axis 11. In the illustrated embodiment, the attachment leg 114 includes a hole 118 wherethrough a bushing 120 is received along with the fastener 100 for pivotal attachment of a respective trailing arm 94 about the lateral axis 104.

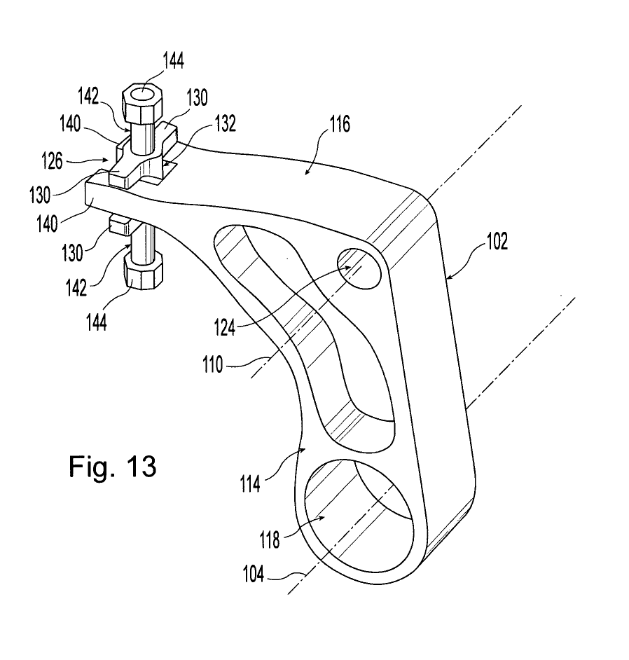

As best seen in FIG. 13, a pivotal connection 111 pivotally secures pivotal links 102 with alignment brackets 107 about a pivot axis 110 that extends laterally and substantially perpendicular to longitudinal axis 11. In the illustrated embodiment, pivotal link 102 includes a hole 124 between the attachment and adjustment legs 114, 116 that is adapted to receive the fastener 106 for thereby pivotally attaching the pivotal link 102 to the alignment bracket legs 108 and the two pivot axes 110 are positioned substantially co-linear.

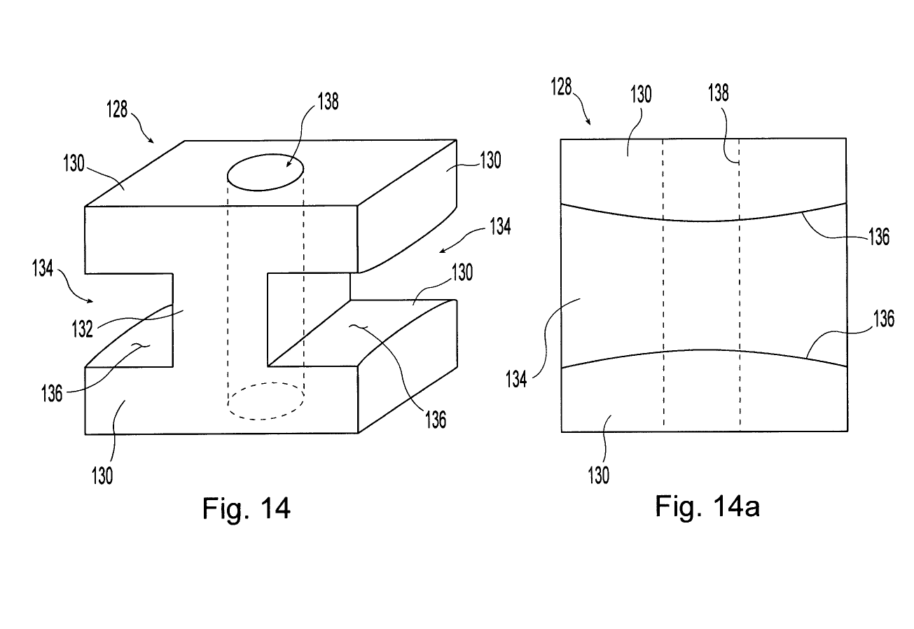

The adjustment leg 116 includes, at its terminal end thereof, a slot or opening 126. An “H” shaped block is adapted to engage the terminal end of the adjustment leg 116 and the slot 126. As best seen in FIG. 14, a positioning member 128 in the form of a “H” block includes upper and lower arms 130 and a central body portion 132 which together define slots or openings 134. It is noted that the inner surfaces 136 of the upper and lower arms 130 are slightly convex shaped as shown. Additionally, a central threaded opening 138 extends through the positioning member/“H” block 128 generally perpendicular to the upper and lower arms 130.

As best seen in FIG. 13, the “H” block 128 is adapted to engage the terminal end of the adjustment leg 116 with the “H” block central body portion 132 received within the slot 126 at the terminal end of the adjustment leg 116. Additionally, the prongs or projecting arms 140 at the terminal end of the adjustment leg 116 which define the slot 126 are received and extend through the slots 134 located between the arms 130 of the “H” block 128.

Referring now also to FIGS. 10-12, a threaded member 142 in the form of a threaded rod is provided and is threadingly engaged in and received through the threaded bore 138 of the “H” block 128. Threaded rod 142 includes nuts 144 rigidly secured at its terminal ends and adapted to be engaged by a common socket tool for rotating the threaded rod 142 about its longitudinal axis. The upper and lower plates 146, 148 extend between the alignment bracket legs 108 and are provided with holes 150 wherethrough the threaded rod 142 is received. Holes 150 are not threaded and are slightly larger than the threaded rod 142 for thereby allowing the threaded rod 142 to freely rotate about its longitudinal axis.

As should now be appreciated, by engaging one of the threaded rod upper or lower nuts 144 with a tool and turning the threaded rod 142 about its longitudinal axis the “H” block 128 which is threadingly engaged thereon is caused to move longitudinally along the threaded rod 142. Moreover, clockwise and counter-clockwise rotation of the threaded rod 142 causes the “H” block 128 to move in opposite directions between the upper and lower plates 146, 148.

The projecting arms/prongs 140 of pivotal links 102 and the slots 134 of positioning members/“H” blocks 128 form an engagement interface 127 between pivotal links 102 and H blocks 128. As the “H” block moves linearly, i.e., in a generally straight line, between the upper and lower plates 146, 148 along threaded rod 142, the prongs 140 of the adjustment leg 116 move in an arcuate path and, in this regard, the arcuate shaped inner surfaces 136 of arms 130 that define slots 134 compensate therefor and allow for maintaining continuous contact and enhance the surface area of such contact between the inner surfaces 136 and the prongs 140 as “H” blocks 128 reposition pivotal links 102. In the illustrated embodiment, inner surfaces 136 are convex surfaces.

Accordingly, as depicted in FIGS. 10-12, by rotating the threaded rod 142 the “H” block 128 which is engaged with the terminal end of the adjustment leg 116 provides the necessary force at the terminal end of the adjustment leg 116 for causing the pivotal link 102 to pivot about the lateral axis 110. Additionally, this pivotal motion causes the lateral axis 104 and the respective trailing arm 94 pivotally attached thereto to move longitudinally with respect to the slide rails 12.

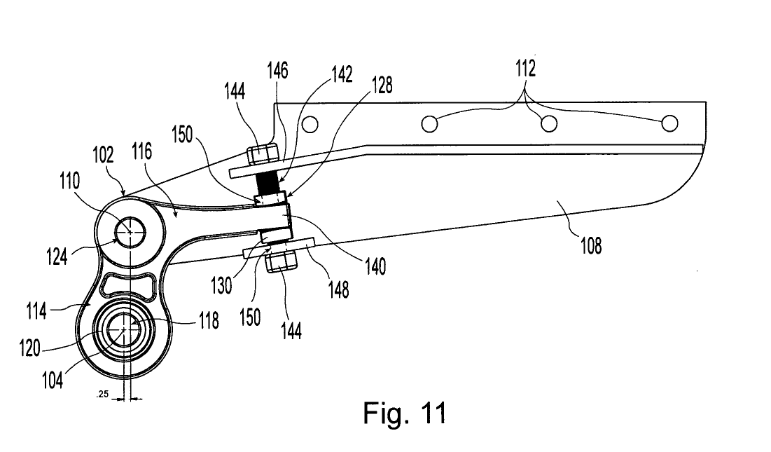

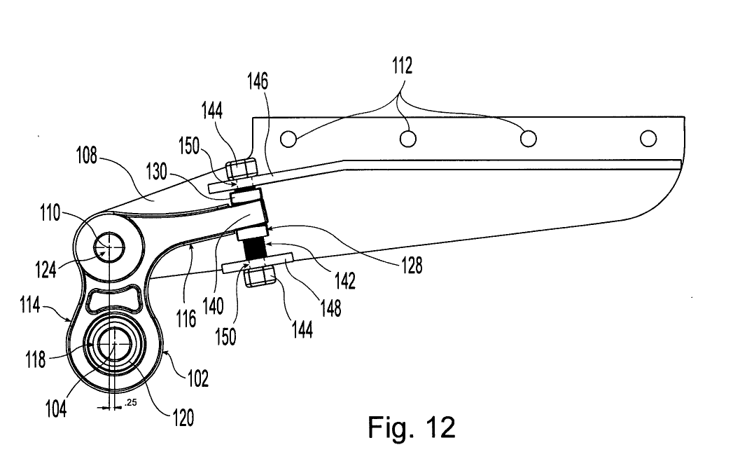

As depicted in FIG. 10, with the adjustment leg 116 generally centered between the upper and lower plates 146, 148 the lateral axis 104 is in its centered position. By rotating the threaded rod 142 in one direction and causing the adjustment leg 116 to travel downwardly as depicted in FIG. 11 near the lower plate 148 the lateral axis 104 is caused to move longitudinally to the left as shown in FIG. 11 or toward the front of the slider assembly 10. Alternatively, by rotating the threaded rod 142 in the opposite direction the adjustment leg 116 is caused to travel along the threaded rod 142 upwardly or near the upper plate 146 thereby causing the lateral axis 104 to move longitudinally to the right as depicted in FIG. 12 or toward the rear of the slider suspension assembly 10.

It is noted that, after the lateral axis 104 is longitudinally adjusted as desired, the pivotal link 102 is fixed for preventing further rotational movement thereof about the axis 110 by securing threaded rod 128 relative to the plates 146, 148 and preventing rotation thereof. Alternatively, a significantly rigid/frictional pivotal connection can be provided between the pivotal link 102 and the alignment bracket legs 108 such that, once pivotally adjusted using the threaded rod 142 and “H” block 128 as described hereinabove, the pivotal link 102 maintains its angular orientation.

As should now be appreciated, “H” block 128 and threaded member 142 form an adjustment mechanism 156 which is used to selectively pivot pivotal links 102 about axes 110 and thereby longitudinally reposition axes 104 and adjust the angular position of axles 24 relative to longitudinal axis 11. Thus, by merely rotating the threaded rods 142 on one or both sides of the suspension assembly 10, at each slide rail 12, the angle between the axles 24 and the slide rails 12 may selectively be adjusted. Advantageously, after mounting the slider suspension assembly 10 onto a trailer chassis the pivotal links 102 are selectively pivotally adjusted causing the left and/or right trailing arms 94 to be longitudinally adjusted forward and/or rearward and for thereby adjusting the angle between the axles 24 and the vehicle chassis. In this manner the axles 24 are selectively adjustable for placing the axles 24 perpendicular to the trailer chassis and the trailer line of travel. While axles 24 will be substantially perpendicular to longitudinal axis 11 when suspension assembly 10 is mounted on the trailer chassis, small angular deviations can have a negative impact on performance and adjustment mechanisms 154 allow the angle of axles 24 to be conveniently adjusted.

It is further noted that while the illustrated embodiment includes a pivotal link 102 and adjustment mechanism 156 coupled to each of the trailing arms 94 located on opposite sides of longitudinal axis 11, a single pivotal link 102 and adjustment mechanism 156 could be used in an alternative embodiment to provide for the angular adjustment of axles 24.

Referring now more particularly to FIGS. 6-9, the suspension assembly 10 is further advantageous in that it provides a soft and comfortable ride under normal or straight line travel while substantially increasing the spring rate and helping to decrease possible roll-over of the trailer during turns. In this regard, as shown in FIGS. 6, 6(a) and 6(b), during normal or straight line travel the trailer body and axles 24 remain generally parallel to one another. Here, the trailer weight is transferred generally equally on both sides of the slider suspension assembly and the weight thereof is generally equally distributed through the suspension springs 82, 74 which dampen relative movement between axle assembly 25 and chassis 13 and include four (4) air springs 82 and two (2) rubber spring members 74 in the illustrated embodiment. Under conditions shown in FIGS. 6, 6(a), 6(b), the spring rate of both of the rubber spring members 74 is at its lowest or softest thereby providing a generally smooth and soft ride as the wheels and axles traverse over road bumps.

As depicted in FIGS. 7, 7(a) and 7(b), when the trailer is moved through a turn or is exposed to significant lateral wind thereby experiencing a horizontal lateral force as depicted by the arrow 152, the trailer starts to tip or lean thereby placing additional load on one side of the suspension. In FIG. 7 this additional load or force is shown being applied on the left side of the suspension system. This additional force causes the air springs 82 and the rubber spring 74 to first compress through the softer spring rate such that the rubber spring upper and lower bulbous sections 76 are compressed into the central thinner area 78. Additional horizontal lateral force as depicted by arrow 152 such as would be experienced with faster and/or sharper turning causes yet additional compression of the air springs 82 and rubber spring member 74 on the left side of the suspension assembly as seen in FIG. 7. Advantageously, however, the spring rate of the rubber spring member 74 is now significantly increased for thereby further countering and resisting the force thereon.

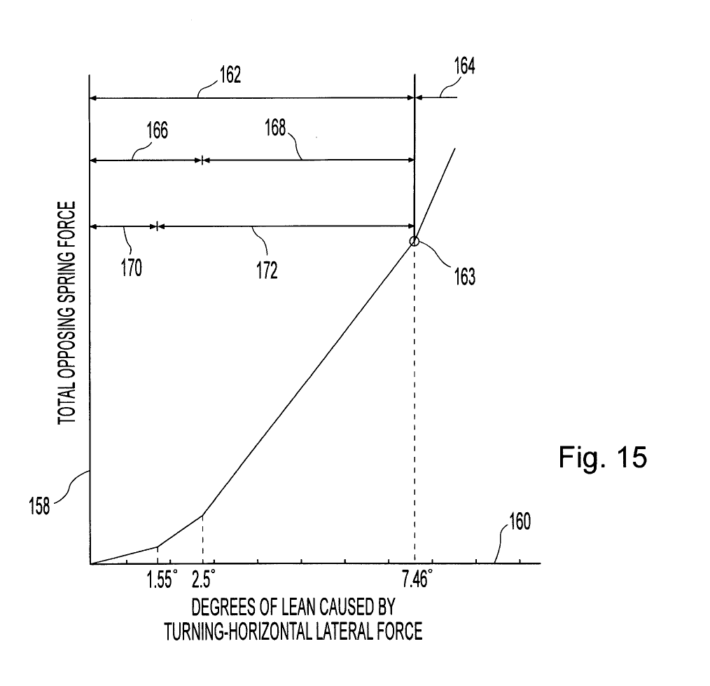

With regard to spring members 74, each of the rubber spring members 74 has a shape that defines two separately shaped sections, i.e., the central section 78 and the upper and lower sections 76. Central section 78 has a smaller cross sectional area than the upper and lower sections 76 which each have a substantially common cross sectional area. Since the material used to form both the central section 78 and the upper and lower sections 76 is the same throughout spring members 74, the smaller central section 78 will have a smaller spring rate than the spring rate of upper and lower sections 76. Thus, when spring members 74 are compressed, the smaller central section 78 will initially be compressed (at the relatively lower spring rate of central section 78) until the force necessary to further compress central section 78 is greater than the force necessary to compress upper and lower sections 76 when upper and lower sections 76 will begin to be compressed (at the relatively larger spring rate of sections 76). In FIG. 15, when the trailer is experiencing a degree of lean between about 0.0 and about 1.55 degrees, the central section 78 of spring member 74 (on the left-hand side in FIGS. 6-9) is being compressed. At about 1.55 degrees of lean, the upper and lower sections 78 of spring member 74 (on the left-hand side in FIGS. 6-9) are being compressed. While the total spring resistance includes the force imparted by air springs 82 in addition to spring members 74, the inflection in the line representing the spring rate that can be seen at about 1.55 degrees of lean is due primarily to the change in the spring rate of the spring member 74 that is being compressed as the trailer is subjected to lean.

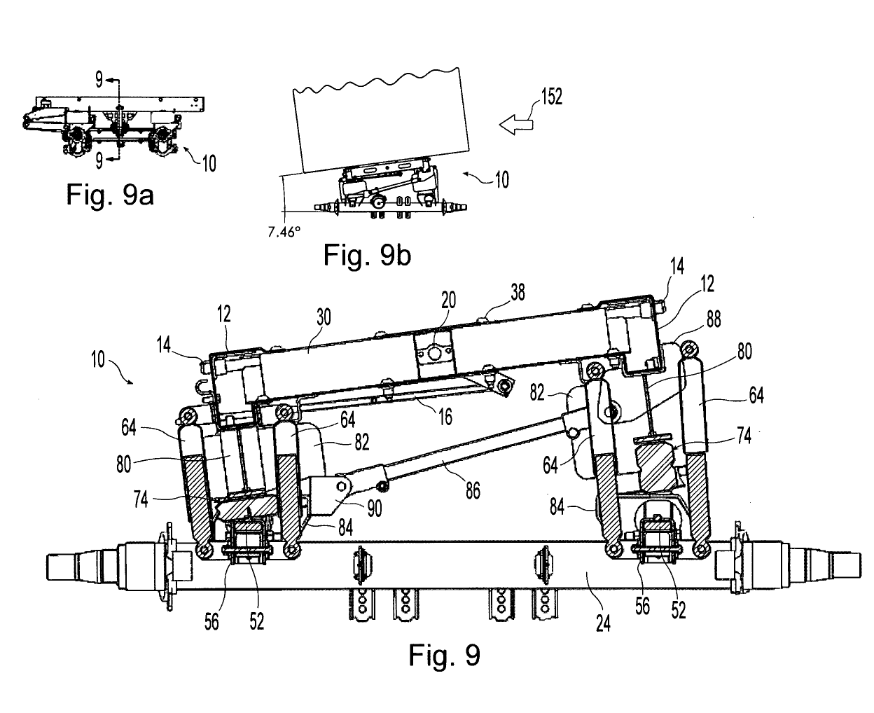

Continued increasing of the horizontal lateral force as depicted by arrow 152 caused by yet sharper or faster turning, as depicted in FIG. 9, causes yet additional compression of the air springs 82 and the rubber spring member 74 on the left side of the suspension assembly. In this position the rubber spring member 74 on the right side is disengaged and no longer in contact with the filler bracket 80 and so it no longer contributes or provides a force upwardly on the right side of the assembly as shown in FIG. 9. (In alternative configurations, spring member 74 could be mounted on filler bracket 80 and the spring member 74 on the right side in FIG. 5 would be lifted out of contact with mounting bracket 56 instead of being disengaged from filler bracket 80.) Moreover, the rubber spring member 74 on the left side continues to compress but is at its highest spring rate for thereby resisting the forces thereon caused by the horizontal lateral force 152.

It is noted that yet additional horizontal lateral force 152 then causes the lift limiting members 64 on the right hand side shown in FIG. 9 to reach their maximum extension such that, any additional leaning of the suspension assembly would require the axle and wheels on the right to be lifted off of the ground or, essentially, be pulled upwardly along with the suspension assembly. As mentioned above, lift limiting members 64 may take various different forms and are telescoping shock absorbers in the illustrated embodiment.

Whether the lift limiting members 64 are telescoping shock absorbers, chains or other suitable flexible member, such members 64 will be secured relative to one of the longitudinal assemblies 53 proximate one end and be secured relative to chassis 13 (e.g., by securing it to rail 12) proximate its other end. The lift limiting members 64 thereby limit vertical separation between the longitudinal assemblies 53 and vehicle chassis 13 within a range having a predetermined maximum limit. In this regard, it is noted that the maximum limit for assembly 10 is reached at 7.46 degrees of tilt and corresponds to the point indicated by reference numeral 163 in FIG. 15.

As can be appreciated, the slider suspension assembly 10, thus, provides a soft ride during normal or straight line operation of the trailer and, as the trailer body experiences a horizontal lateral force during turns, the spring rate opposing such horizontal lateral force continually increases so as to match any increasing horizontal lateral force and thereby minimizing the potential for roll-over of the trailer. Depicted in FIG. 15 is a graph generally diagrammatically describing the total opposing spring force of the suspension assembly 10 (vertical axis of FIG. 15 is indicated by reference numeral 158). This total opposing spring force includes the forces exerted by the air springs 82 and spring members 74 on both sides of longitudinal axis 11. The horizontal axis of FIG. 15 indicated by reference numeral 160 represents the degrees of lean of the trailer. As can be seen, the total opposing spring force increases as the lean of the trailer increases. Moreover, it is noted that the slope of the line representing the spring force is the effective total spring rate of suspension system 10. As can be clearly seen in FIG. 15, the line representing the opposing spring force has four linear sections with the slope of the line (and, thus, the spring rate of suspension system 10) progressively increases as the degree of lean increases.

More specifically, as shown in FIG. 15, from 0.0° to about 1.55° lean, the air springs 82 and the rubber spring member 74 opposing the horizontal lateral force provide a generally minimal opposing spring rate and thereby provide a generally soft ride. FIG. 15 includes lines 170, 172 that indicate two zones corresponding to the behavior of spring member 74 located on the left-hand side in FIGS. 6-9. In zone 170 (which continues to the left of axis 158 until the spring member 74 would lose contact with bracket 80 if the trailer were to lean in the opposite direction), the left-hand spring member 74 of FIGS. 6-9 exerts a relatively minimal spring rate because it is the central section 78 of the spring member 74 that is being compressed. As the lean axis increases beyond 1.55° and enters zone 172, the left-hand spring member 74 of FIGS. 6-9 exerts a larger spring rate because the upper and lower sections 76 of the left-hand spring member are now being compressed.

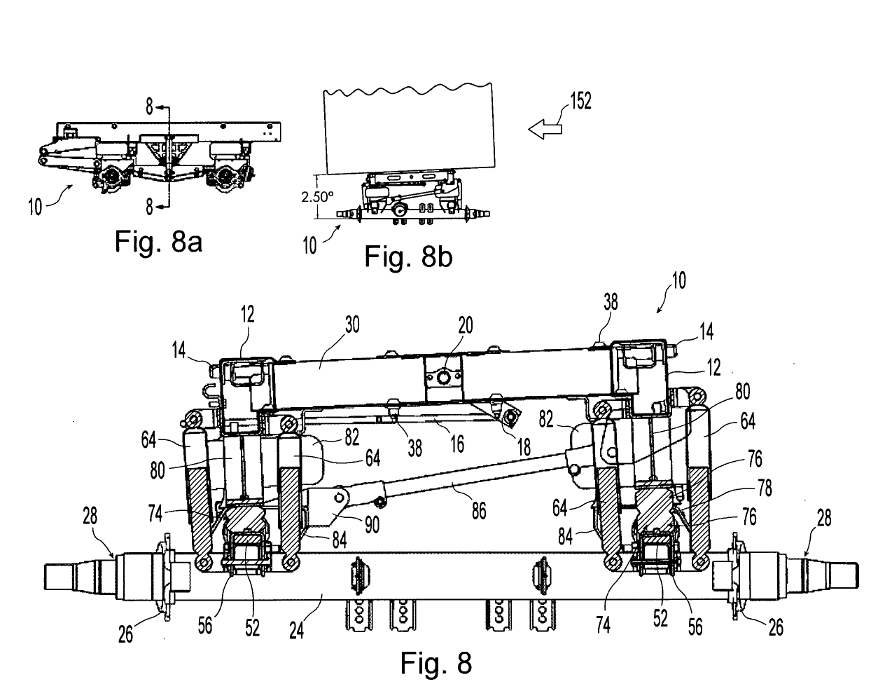

Between about 1.55° and 2.5° lean as also depicted in FIG. 8, the rubber spring member 74 that is being more severely compressed (e.g., the spring member 74 on the left-hand side of FIGS. 6-9) substantially increases its spring rate thereby increasing the overall opposing spring rate as the horizontal lateral force increases and the lean reaches about 2.5°. After about a 2.5° lean, the rubber spring member 74 on the other side of the suspension assembly (e.g., the spring member 74 on the right-hand side of FIGS. 6-9) is no longer in compression or, essentially, is no longer in complete contact between both the filler bracket 80 and the mounting bracket 56. Therefore, the rubber spring member 74 on the right side no longer provides a force upwardly to the bracket 80 (i.e., it no longer exerts a biasing force urging its longitudinal assembly 53 away from chassis 13).

In other words, in the region indicated by reference numeral 166, the spring member 74 located on the right-hand side in FIGS. 6-9 is exerting a biasing force urging its associated longitudinal assembly 53 away from chassis 13. Once the vertical separation between the longitudinal assembly 53 and chassis 13 for the right-hand side of FIGS. 6-9 increases beyond region 166, the spring member 74 on the right-hand side in FIGS. 6-9 loses contact with bracket 80 and no longer exerts a biasing force that urges its associated longitudinal assembly 53 away from chassis 13. (It is noted that zones 170, 172 in FIG. 15 are associated with the left-hand longitudinal assembly 53 and spring member 74 while the regions 166, 168 are associated with the right-hand longitudinal assembly 53 and spring member 74.)

The rubber spring member 74 and air springs 82 on the opposite side, e.g., the left-hand side in FIGS. 6-9, are still opposing the horizontal lateral force. The increase in the spring rate between 2.5° and 7.46° degrees of lean is due to the disengagement of one of the spring members 74 (e.g., the right-hand spring member 74 is biasingly disengaged in FIG. 9). After about 7.46° of lean, the shock absorbers on the right side of FIGS. 6-9 reach their full extension and so the weight of the axle and wheels thereunder pull down on the shock absorber and act to yet further contribute to the opposing spring force as depicted in the graph or, more accurately, weigh down the right side of the suspension assembly for thereby helping to prevent potential roll-over. Thus, for the right-hand side of FIGS. 6-9, the region in FIG. 15 indicated by reference numeral 168 corresponds to when the right-hand side spring member 74 is exerting no upward biasing force and an ever-increasing vertical separation between the longitudinal assembly 53 and chassis is occurring as the lean angle increases toward the maximum limit of such separation that occurs at 7.46° of lean (point 163 in FIG. 15) when lift limiting members 64 on the right-hand side in FIGS. 6-9 prevent further vertical separation.

FIG. 15 depicts two ranges indicated by reference numerals 162, 164 that correspond to this action of the right-hand side longitudinal assembly 53 in FIGS. 6-9. In range 162, all of the wheels of the trailer are still in contact with the ground surface. At point 163, the lift limiting member 164 on the right-hand side of FIGS. 6-9 has reached it maximum limit and prevents further vertical separation of its associated longitudinal assembly 153 from vehicle chassis 13. Once the lift limiting member 64 has reached this maximum value, the wheels of the trailer on the right-hand side of FIGS. 6-9 will begin being lifted off of the ground surface and will be lifted progressively higher above the ground surface as the degree of lean is further increased. Of course, once the wheels of the trailer begin to lift, if the degree of lean continues to increase, the trailer will eventually tip.

It is noted that if FIG. 15 were to depict a lean angle in the opposite direction, FIG. 15 would be symmetrical about axis 158. Thus, zone 170 would continue to the left until it reached a value of 2.5° when the spring member 74 would lose contact with bracket 80 and no longer exert a biasing force. Similarly, region 166, which corresponds to when the right-hand side spring member 74 exerts a biasing force, would have two zones corresponding to zones 170 and 172 shown in FIG. 15 for the left-hand spring member 74 and would experience a dramatic increase in spring rate when the lean angle in the opposite direction increased beyond 1.55° and the upper and lower regions 76 of the spring member begin to be compressed.

In other words, as the trailer tilts in a particular direction and one of the longitudinal assemblies 53 is moved through its limited range 162 of vertical separation toward the predetermined maximum limit set by lift limiting member 64, spring member 74 will exert a force urging its associated longitudinal assembly 53 away from the vehicle chassis 13 within a first biasing region 166 of its limited range 162 and then spring member 74 will be biasingly disengaged and go through a second non-biasing region 168 of its limited range 162 where it no longer contributes a biasing force that assists the lateral force 152 urging the trailer to roll-over.

Furthermore, each of the spring members 74 have at least two effective spring rates wherein the spring rate of the spring member 74 is increased as the spring member 74 is further compressed. In other words, as each of the longitudinal assemblies 53 are moved through their ranges 162 of vertical separation within the first biasing regions 170 of their associated spring members 74 in a direction toward the predetermined maximum limit 163 of the longitudinal assembly, the spring member 74 associated with the longitudinal assembly 53 that is moving toward its maximum limit 163 of vertical separation will exert a spring force at a first spring rate in a first spring rate zone 170 and then at a second spring rate in a second spring rate zone 172. The second spring rate of each spring member 74 is greater than the first spring rate of that particular spring member 74. Thus, the total spring rate of the assembly 10 will be increased when the spring rate of the spring member 74 that is being compressed is increased.

Thus, the characteristics of the illustrated spring members 74 are responsible for the increases of the overall spring rate of assembly 10 that occur at 1.55° of lean and at 2.5° of lean. At 1.55° of lean, the spring member 74 being compressed, e.g., the left-hand side spring member 74 in FIGS. 6-9, will experience an increase in its spring rate because its upper and lower sections 76 will begin to be compressed. At 2.5° of lean, the opposite spring member 74, e.g., the right-hand side spring member 74 in FIGS. 6-9, will be biasingly disengaged and no longer contribute to the overall overturning force acting on the trailer thereby increasing the overall spring rate of suspension assembly 10. At 7.46° of lean, a lift limiting member 64, e.g., on the right-hand side in FIGS. 6-9, will prevent further vertical separation between the vehicle chassis and its associated longitudinal assembly 53 resulting the lifting of the vehicle wheels and yet another increase in the overall effective spring rate of the suspension assembly 10.

The present invention relates to suspension systems for use in large trailers such as semi trailers. In this regard, it is noted that the illustrated suspension system 10 is a sliding suspension system and axle assembly 25, trailing arms 94, pivotal links 102 and adjustment mechanisms 156 are all supported on and are longitudinally repositionable with sliding rails 12. As evident from the discussion presented above, the present invention provides an improved suspension system, such as a slider suspension system, wherein: the position or angle of the axles are selectively adjustable relative to the trailer longitudinal line of travel for assuring the axles are perpendicular thereto; the suspension spring rate or stiffness increases as the horizontal lateral force increases for thereby increasing roll stability while maintaining a soft comfortable ride under normal operation; and, the slider frame thereof is manufacturable at a relatively lower cost while being easily modifiable for accommodating various size trailer chassis.

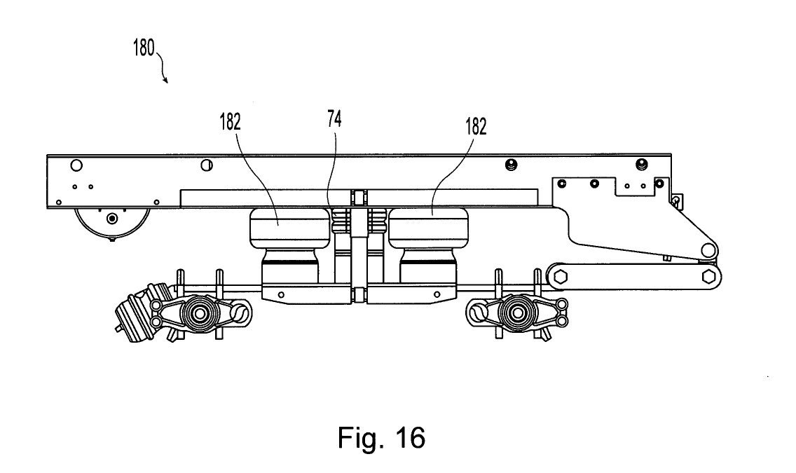

FIG. 16 illustrates another embodiment of another slider suspension assembly 180 constructed in accordance with the principles of the present invention. Suspension assembly 180 is similar to assembly 10 except for the location of air springs 182 which are located adjacent opposite longitudinal sides of spring members 74 instead of directly over axles 24.

While this invention has been described as having an exemplary design, the present invention may be further modified within the spirit and scope of this disclosure. This application is therefore intended to cover any variations, uses, or adaptations of the invention using its general principles.

What is claimed is:

1. A sliding suspension system for mounting on a trailer chassis defining a longitudinal axis; said suspension system comprising:
first and second longitudinally extending slide rails, said first and second rails being slidably engageable with the trailer chassis;
an axle assembly secured to said suspension system and including first and second axles extending substantially perpendicular to said longitudinal axis;
at least one suspension spring member coupled with the axle assembly and adapted to dampen relative movement between said axle assembly and the trailer chassis;
at least one laterally extending cross beam secured to said first rail and to said second rail;
at least one central connecting member; and
first, second, third and fourth bracing members, said first and second bracing members each being secured to said first rail and said central connecting member and extending therebetween, said third and fourth bracing members each being secured to said second rail and said central connecting member and extending therebetween wherein said first, second, third and fourth bracing members are arranged in a substantially X-shaped configuration between said first and second rails.

2. The suspension system of claim 1 wherein each of said bracing members is disposed at an approximately 45 degree angle relative to said longitudinal axis.

3. The suspension system of claim 1 wherein each of said bracing members has a substantially S-shaped cross section.

4. The suspension system of claim 1 wherein each of said bracing members is secured to said central connecting member with at least one fastener and each of said bracing members is secured to a respective one of said first and second rails with at least one fastener.

5. The suspension system of claim 4 wherein each of said fasteners exerts a predefined clamping force.

6. The suspension system of claim 1 wherein each of said bracing members includes a first flange, a second flange and a central web extending between said first and second flanges and wherein said at least one central connecting member includes first and second substantially planar metal plates, said first metal plate being secured to said first flange of each of said bracing members and said second metal plate being secured to said second flange of each of said bracing members.

7. The suspension system of claim 6 wherein each of said bracing members has a substantially S-shaped cross section.

8. The suspension system of claim 6 wherein each of said first and second rails has a substantially C-shaped cross section with a pair of projecting flanges disposed at opposite ends of an opening formed by said cross section, each of said first flanges of said bracing members being secured to one of said projecting flanges and each of said second flanges of said bracing members being secured to the other of said projecting flanges on a respective one of said first and second rails.

9. The suspension system of claim 8 wherein each of said bracing members has a substantially S-shaped cross section and each of said bracing members is secured to said first and second metal plates and said projecting flanges with fasteners.

10. The suspension system of claim 9 further comprising a first locking pin retractably disposed on said first rail and a second locking pin retractably disposed on said second rail, said first and second locking pins being adapted to selectively engage the trailer chassis and secure said suspension system at a selected longitudinal position on the trailer chassis.

11. The suspension system of claim 10 further comprising a second laterally extending cross beam member secured to said first rail and to said second rail, said first, second, third and fourth bracing members being disposed longitudinally between said cross beam members and a pair of trailing arms pivotally securing said axle assembly relative to said first and second rails.

12. A method of assembling a sliding suspension system for a trailer chassis; said method comprising:
providing first and second slide rails adapted to be slidably engaged with the trailer chassis;
providing at least one cross beam;
providing at least one connecting member;
providing first, second, third and fourth bracing members;
securing first and second rails together wherein the first and second rails are disposed substantially parallel and define a longitudinal axis by attaching the cross beam to the first rail with at least one fastener and to the second rail with at least one fastener; attaching the first and second bracing members to the first rail with at least one fastener and to the at least one connecting member with at least one fastener; and attaching the third and fourth bracing members to the second rail with at least one fastener and to the at least one connecting member with at least one fastener wherein the selected bracing members arranged in a substantially X-shaped configuration between the first and second rails;
attaching an axle assembly to the suspension system wherein the axle assembly includes first and second axles extending substantially perpendicular to the longitudinal axis; and
mounting at least one suspension spring member on the suspension system wherein the suspension spring member is positioned to dampen movement of the axle assembly.

13. The method of claim 12 wherein the step of providing first, second, third and fourth bracing members includes providing a plurality of variable length bracing members and said method further comprises determining first, second, third and fourth bracing member lengths and selecting the first, second, third and fourth bracing members from the plurality of rails by selecting bracing members having a length corresponding to the determined first, second, third and fourth bracing member lengths.

14. The method of claim 13 wherein each of the selected first, second, third and fourth bracing member lengths is substantially equivalent.

15. The method of claim 12 wherein the step of providing first and second slide rails includes providing a plurality of variable length slide rails and said method further comprises determining a rail length and selecting the first and second rails from the plurality of rails by selecting rails having a length corresponding to the determined rail length.

16. The method of claim 12 further comprising the step of slidably mounting the sliding suspension system on the trailer chassis.

17. The method of claim 12 wherein each of the bracing members has a substantially S-shaped cross section.

18. The method of claim 12 wherein attaching each of the bracing members to the connecting member with at least one fastener includes installing the fasteners such that the fasteners exert a predefined clamping force and wherein attaching each of the bracing members to one of the first and second rails with at least one fastener includes installing the fasteners such that the fasteners exert a predefined clamping force.

19. The method of claim 12 wherein the connecting member is a substantially planar metal plate.

20. The method of claim 12 wherein each of the bracing members includes a first flange, a second flange and a central web extending between the first and second flanges and the at least one connecting member includes first and second substantially planar metal plates, and wherein attaching each of the bracing members to the at least one connecting member includes attaching the first flange of the bracing member to the first metal plate and the second flange of the bracing member to the second metal plate.

21. The method of claim 20 wherein each of the first and second rails has a substantially C-shaped cross section with a pair of projecting flanges disposed at opposite ends of an opening formed by the cross section, and wherein attaching each of the bracing members to one of the first and second rails includes attaching the first flanges of the bracing member to one of the projecting flanges and attaching the second flanges of the bracing member to the other of the projecting flanges.

22. The method of claim 21 wherein each of the bracing members has a substantially S-shaped cross section and each of the fasteners attaching the bracing members to the first and second metal plates is installed such that the fasteners exert a predefined clamping force.
